(19) United States
(12) Patent Application Publication
(10) Pub. No.: US 2021/0401040 A1
(43) Pub. Date: Dec. 30, 2021

(54) ELECTRONIC SMOKING DEVICE

(71) Applicant: Fontem Holdings 1 B.V., Amsterdam (NL)

(72) Inventor: Vaclav BORKOVEC, Hamburg (DE)

(21) Appl. No.: 17/294,669

(22) PCT Filed: Nov. 19, 2019
(86) PCT No.: PCT/EP2019/081789

§ 371 Date: May 17, 2021

(30) Foreign Application Priority Data
Nov. 20, 2018 (EP) 18207134.0

(51) Int. Cl. A24F 40/30; A24F 40/10; A24F 40/42; A24F 40/20; A24D 1/20; A24F 40/46; A24F 40/44; H05B 3/42

(52) U.S. Cl. CPC A24F 40/30; A24F 40/10; A24F 40/42; H05B 3/42; A24D 1/20; A24F 40/46; A24F 40/44; A24F 40/20

(57) ABSTRACT

The invention relates to an electronic smoking device (10) comprising a power supply portion (12) with a power supply (18) and an atomizer portion (14). The atomizer portion comprises a liquid reservoir (34) and an atomizer (26) operable when connected to the power supply to atomize liquid stored in the liquid reservoir. The atomizer portion further comprises a heating device (28), wherein a tobacco element (46) is position between the heating device and the liquid reservoir such that the liquid passes the tobacco element to absorb the tobacco flavor of the tobacco element before being vaporized by the heating device.

### FIELD OF INVENTION

The present invention relates generally to electronic smoking devices and in particular electronic cigarettes.

### BACKGROUND OF THE INVENTION

An electronic smoking device, such as an electronic cigarette (e-cigarette), typically has a housing accommodating an electric power source (e.g. a single use or rechargeable battery, electrical plug, or other power source), and an electrically operable atomizer. The atomizer vaporizes or atomizes liquid supplied from a reservoir and provides vaporized or atomized liquid as an aerosol. Control electronics control the activation of the atomizer. In some electronic cigarettes, an airflow sensor is provided within the electronic smoking device, which detects a user puffing on the device (e.g., by sensing an under-pressure or an air flow pattern through the device). The airflow sensor indicates or signals the puff to the control electronics to power up the device and generate vapor. In other e-cigarettes, a switch is used to power up the e-cigarette to generate a puff of vapor.

To give the electronic smoking device a more cigarette like taste hybrid electronic smoking devices are known, having two separate heating chambers, one for the liquid and one for the tobacco, to add tobacco taste to the liquid.

### SUMMARY OF THE INVENTION

In accordance with one aspect of the present invention there is provided an electronic smoking device comprising a power supply portion with a power supply and an atomizer/liquid reservoir portion. The atomizer/liquid reservoir portion comprises a liquid reservoir and an atomizer operable when connected to the power supply to atomize liquid stored in the liquid reservoir. The atomizer/liquid reservoir portion further comprises a heating element, wherein a tobacco element comprising tobacco is in position between the liquid reservoir and the heating element of the atomizer. As the liquid stored in the liquid reservoir passes the tobacco element, it adsorbs the tobacco flavor of the tobacco element before the liquid is vaporized by the heating element. The idea is to use tobacco as part of the wicking system of an electronic smoking device, in order to turn it into a hybrid product. The tobacco adds flavor and nicotine to the liquid to give it a more cigarette like taste. The idea is to add the flavor and the nicotine of the tobacco into the liquid just before it is transported to the atomizer.

In accordance with another aspect of the invention there is provided a method of assembling an electronic smoking device with a power supply portion comprising a power supply and an atomizer portion comprising a liquid reservoir. A tobacco element is inserted into a central passage of the electronic smoking device and connected to the atomizer, wherein the tobacco element is fluidly connected to the liquid reservoir such that a liquid is transported to the atomizer via the tobacco element.

The characteristics, features and advantages of this invention and the manner in which they are obtained as described above, will become more apparent and be more clearly understood in connection with the following description of exemplary embodiments, which are explained with reference to the accompanying drawings.

### BRIEF DESCRIPTION OF THE DRAWINGS

In the drawings, same element numbers indicate same elements in each of the views:

FIG. 1 is a schematic cross-sectional illustration of an exemplary e-cigarette;

FIG. 2 shows a first embodiment of an atomizer with a heating coil and a wick;

FIG. 3 shows a cross-sectional view on the atomizer/liquid reservoir portion of an electronic smoking device;

FIG. 4 shows a schematic illustration of the atomizer of an electronic smoking device;

FIG. 5 is a schematic illustration of a tube shaped hollow tobacco rod.

### DESCRIPTION OF THE PREFERRED EMBODIMENTS

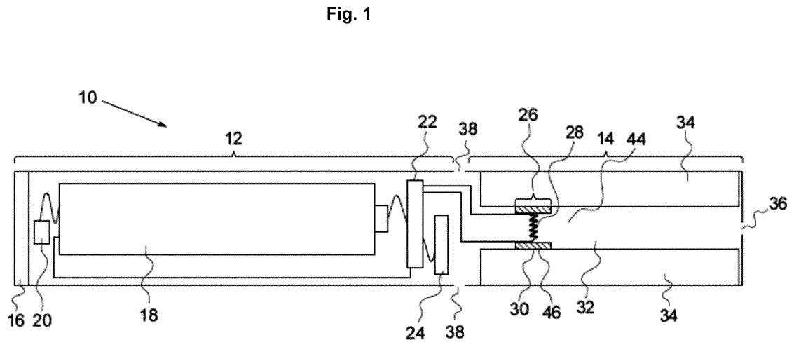

Throughout the following, an electronic smoking device will be exemplarily described with reference to an e-cigarette. As is shown in FIG. 1, an e-cigarette 10 typically has a housing comprising a cylindrical hollow tube having an end cap 16. The cylindrical hollow tube may be a single-piece or a multiple-piece tube. In FIG. 1, the cylindrical hollow tube is shown as a two-piece structure having a power supply portion 12 and an atomizer/liquid reservoir portion 14. Together the power supply portion 12 and the atomizer/liquid reservoir portion 14 form a cylindrical tube which can be approximately the same size and shape as a conventional cigarette, typically about 100 mm with a 7.5 mm diameter, although lengths may range from 70 to 150 or 180 mm, and diameters from 5 to 28 mm.

The power supply portion 12 and atomizer/liquid reservoir portion 14 are typically made of metal, e.g. steel or aluminum, or of hardwearing plastic and act together with the end cap 16 to provide a housing to contain the components of the e-cigarette 10. The power supply portion 12 and an atomizer/liquid reservoir portion 14 may be configured to fit together by a friction push fit, a snap fit, or a bayonet attachment, magnetic fit, or screw threads. The end cap 16 is provided at the front end of the power supply portion 12. The end cap 16 may be made from translucent plastic or other translucent material to allow a light-emitting diode (LED) 20 positioned near the end cap to emit light through the end cap. The end cap can be made of metal or other materials that do not allow light to pass.

An air inlet may be provided in the end cap, at the edge of the inlet next to the cylindrical hollow tube, anywhere along the length of the cylindrical hollow tube, or at the connection of the power supply portion 12 and the atomizer/liquid reservoir portion 14. FIG. 1 shows a pair of air inlets 38 provided at the intersection between the power supply portion 12 and the atomizer/liquid reservoir portion 14.

A power supply 18, preferably a battery 18, an LED 20, control electronics 22 and optionally an airflow sensor 24 are provided within the cylindrical hollow tube power supply portion 12. The battery 18 is electrically connected to the control electronics 22, which are electrically connected to the LED 20 and the airflow sensor 24. In this example, the LED 20 is at the front end of the power supply portion 12, adjacent to the end cap 16 and the control electronics 22 and airflow sensor 24 are provided in the central cavity at the other end of the battery 18 adjacent to the atomizer/liquid reservoir portion 14.

The airflow sensor 24 acts as a puff detector, detecting a user puffing or sucking on the atomizer/liquid reservoir portion 14 of the e-cigarette 10. The airflow sensor 24 can be any suitable sensor for detecting changes in airflow or air pressure, such as a microphone switch including a deformable membrane which is caused to move by variations in air pressure. Alternatively, the sensor may be a Hall element or an electro-mechanical sensor.

The control electronics 22 are also connected to an atomizer 26. In the example shown, the atomizer 26 includes a heating element 28, preferably a heating coil which is wrapped around a wick 30 extending across a central passage 32 of the atomizer/liquid reservoir portion 14. The heating element 28 may be positioned anywhere in the atomizer 26 and may be transverse or parallel to the liquid reservoir 34. The wick 30 and heating element 28 do not completely block the central passage 32. Rather an air gap is provided on either side of the heating element 28 enabling air to flow past the heating element 28 and the wick 30. The atomizer 26 may alternatively use other forms of heating elements 28, such as ceramic heaters, or fiber or mesh material heaters. Nonresistance heating elements such as sonic, piezo and jet spray may also be used in the atomizer 26 in place of the heating coil.

The central passage 32 is surrounded by a cylindrical liquid reservoir 34 with the ends of the wick 30 abutting or extending into the liquid reservoir 34. The wick 30 may be a porous material such as a bundle of fiberglass fibers, with liquid 44 in the liquid reservoir 34 drawn by capillary action from the ends of the wick 30 towards the central portion of the wick 30 encircled by the heating element 28. Alternatively, the wick 30 may be of porous material such as cotton or contain a porous layer 76.

The liquid reservoir 34 may alternatively include wadding soaked in liquid which encircles the central passage 32 with the ends of the wick 30 abutting the wadding. In other embodiments, the liquid reservoir 34 may comprise a toroidal cavity arranged to be filled with liquid 44 and with the ends of the wick 30 extending into the toroidal cavity.

An air inhalation port 36 is provided at the back end of the atomizer/liquid reservoir portion 14 remote from the end cap 16. The inhalation port 36 may be formed from the cylindrical hollow tube atomizer/liquid reservoir portion 14 or maybe formed in an end cap.

In use, a user sucks on the e-cigarette 10. This causes air to be drawn into the e-cigarette 10 via one or more air inlets, such as air inlets 38, and to be drawn through the central passage 32 towards the air inhalation port 36. The change in air pressure which arises is detected by the airflow sensor 24, which generates an electrical signal that is passed to the control electronics 22. In response to the signal, the control electronics 22 activate the heating element 28, which causes liquid present in the wick 30 to be vaporized creating an aerosol (which may comprise gaseous and liquid components) within the central passage 32. As the user continues to suck on the e-cigarette 10, this aerosol is drawn through the central passage 32 and inhaled by the user. At the same time, the control electronics 22 also activate the LED 20 causing the LED 20 to light up which is visible via the translucent end cap 16 mimicking the appearance of a glowing ember at the end of a conventional cigarette. As liquid 44 present in the wick 30 is converted into an aerosol, more liquid 44 is drawn into the wick 30 from the liquid reservoir 34 by capillary action and thus is available to be converted into an aerosol through subsequent activation of the heating element 28, preferably heating coil 28. To draw the liquid 44 from the liquid reservoir 34 to the wick 30, the liquid 44 has to penetrate the tobacco element 46, which adds tobacco flavor and nicotine to the liquid, giving the user a more cigarette like taste and allowing to add nicotine to the liquid, even when the liquid itself does not contain any nicotine.

Some e-cigarettes are intended to be disposable and the electric power in the battery 18 is intended to be sufficient to vaporize the liquid 44 contained within the liquid reservoir 34, after which the e-cigarette 10 is thrown away. In other embodiments the battery 18 is rechargeable and the liquid reservoir 34 is refillable. In the cases where the liquid reservoir 34 is a toroidal cavity, this may be achieved by refilling the liquid reservoir 34 via a refill port. In other embodiments the atomizer/liquid reservoir portion 14 of the e-cigarette 10 is detachable from the power supply portion 12 and a new atomizer/liquid reservoir portion 14 can be fitted with a new liquid reservoir 34 thereby replenishing the supply of liquid 44. In some cases, replacing the liquid reservoir 34 may involve replacement of the heating element 28 and the wick 30 along with the replacement of the liquid reservoir 34. A replaceable unit comprising the atomizer 26 and the liquid reservoir 34 is called a cartomizer.

The new liquid reservoir 34 may be in the form of a cartridge having a central passage 32 through which a user inhales aerosol. In other embodiments, aerosol may flow around the exterior of the cartridge 32 to an air inhalation port 36.

Of course, in addition to the above description of the structure and function of a typical e-cigarette 10, variations also exist. For example, the LED 20 may be omitted. The airflow sensor 24 may be placed adjacent the end cap 16 rather than in the middle of the e-cigarette. The airflow sensor 24 may be replaced with a switch which enables a user to activate the e-cigarette manually rather than in response to the detection of a change in air flow or air pressure.

Different types of atomizers may be used. Thus, for example, the atomizer may have a heating coil in a cavity in the interior of a porous body soaked in liquid. In this design aerosol is generated by evaporating the liquid within the porous body either by activation of the coil heating the porous body or alternatively by the heated air passing over or through the porous body. Alternatively, the atomizer may use a piezoelectric atomizer to create an aerosol either in combination or in the absence of a heater. A fluid connection between the liquid reservoir 34 and the atomizer 26 is formed via a porous tobacco element 46 positioned in between an outlet of the liquid reservoir 34 and the wick 30, such that the liquid 44 has to penetrate the tobacco element 46 to be drawn into the wick 30 and vaporized afterwards.

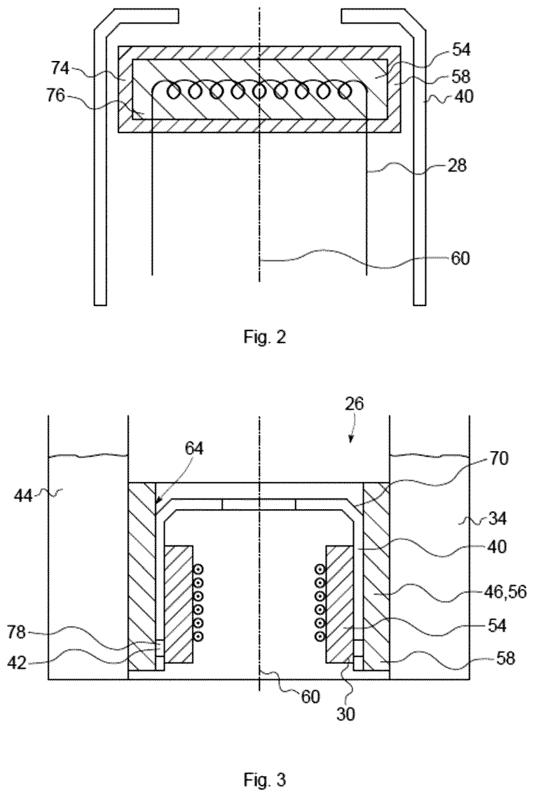

FIG. 2 shows a first embodiment of an atomizer 26 of an e-cigarette 10 as shown in FIG. 1. The atomizer 26 comprises a heating element 28 and a wick 30. The heating element 28 contains preferably a metal heating coil or a ceramic heating element, wherein the heating element 28 is at least partly wrapped around the wick 30. The wick 30 comprises at least one porous layer 76 such as a cotton layer or a bundle of fiberglass fibers and a tobacco layer 74 that is wrapped around the porous layer 76 of the wick 30. The heating element 28 is at least partly surrounded by the wick 30. The tobacco layer 74 encases the porous layer 76 of the wick 30 so that the liquid 44 stored in the liquid reservoir 34 penetrates the tobacco layer 74 before being vaporized by the heating element 28.

FIG. 3 shows a cross-sectional view on the atomizer/liquid reservoir portion 14 of an electronic smoking device 10. The atomizer/liquid reservoir portion 14 comprises a liquid reservoir 34 and an atomizer 26. The liquid reservoir 34 is filled with a liquid 44. The atomizer 26 comprises a coil housing 40 and a heating coil 28, wherein a wick 30 is connected to the heating coil 28. The wick 30 comprises a porous material such as cotton 54 or fiberglass fibers. The coil housing 40 has at least one orifice 78 fluidly connecting the liquid reservoir 34 to the wick 30. A tobacco element 46 in form of a hollow tobacco rod 56 is positioned between the liquid reservoir 34 and the coil housing 40 of the atomizer 26. The coil housing 40 may have a chamfer 70 on its front orientated towards the air inhalation port 36 of the electronic smoking device 10 to simplify a press-fit of the tobacco rod 56 on the coil housing 40 of the atomizer 26. The tobacco rod 56 is covering the orifices 78 of the coil housing 40 such that the liquid has to penetrate the tobacco rod 56 to be drawn into the wick 30. While penetrating the tobacco rod 56 the liquid 44 adsorbs the tobacco taste and the nicotine of the tobacco element 46 in order to give the liquid 44 a more cigarette like taste.

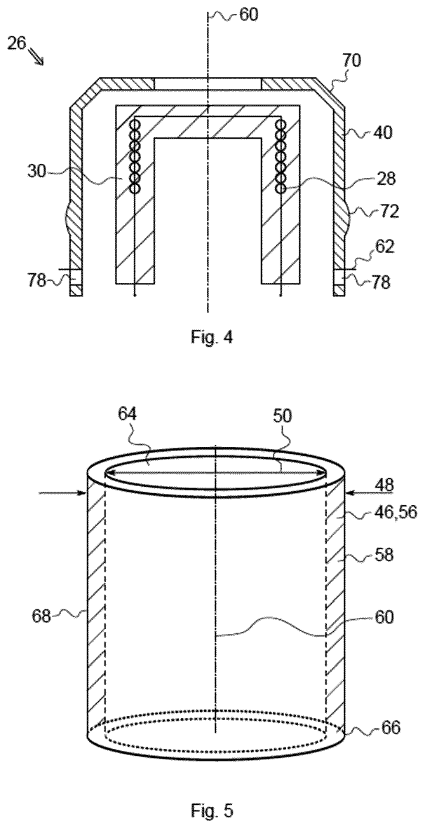

FIG. 4 shows an atomizer 26 of an electronic smoking device 10. The atomizer 26 comprises a metallic coil housing 40 and a heating coil 28 disposed in the coil housing 28. The heating coil 28 is covered by a porous material such as a bundle of fiberglass fibers or cotton. Alternatively, the porous material is at least party surrounded by the heating coil 28. The coil housing 40 has two orifices with an offset of 180° to each other, through which the liquid 44 can be drawn into the atomizer 26 and is received in the wick 30, before the liquid 44 is vaporized by the heating coil 28. The heating coil 28 is connectable to the power supply portion 12 to heat up the liquid 44 soaked up by the wick 30, when the heating coil 28 is activated and heated up to its operating temperature.

FIG. 5 shows tobacco element 46 in form of a tube shaped hollow tobacco rod 56. The tobacco rod 56 has an inner diameter 50 adjusted to the diameter of the coil housing 40 and an outer diameter 48 adjusted to the liquid reservoir 34. The tobacco rod 56 has a central orifice 64 to receive the coil housing 40 of the atomizer 26. The tobacco rod 56 may have a chamfer 66 to simplify the adjustment of the tobacco rod 56 on the coil housing 40 of the atomizer 26. The tobacco element 46 may comprise a retaining element 68 such as a wire or a frame, to keep the tobacco 58 of the tobacco rod 56 in a tube-like shape and prevent parts of the tobacco 58 to fall into the gap between the liquid reservoir 34 and the coil housing 40.

In summary, in one aspect the electronic smoking device 10 has a power supply portion 12 comprising a power supply 18 and an atomizer/liquid reservoir portion 14 comprising a liquid reservoir 34 and an atomizer 26 operable when connected to the power supply 18 to atomize liquid 44 stored in the liquid reservoir 34. The atomizer/liquid reservoir portion 14 further comprises a heating element 28, wherein a tobacco element 46 comprising tobacco 58 is positioned between the liquid reservoir 34 and the heating element 28 of the atomizer 26 such that the liquid 44 stored in the liquid reservoir 34 passes the tobacco element 46 to adsorb the tobacco flavor and nicotine of the tobacco element 46 before being atomized or vaporized by the heating element 28. This allows to transform a single heating electronic smoking device into a hybrid product adding tobacco taste and nicotine to the liquid to give the electronic smoking device a more cigarette like taste.

According to a preferred embodiment of the electronic smoking device 10, the tobacco element 46 is a hollow tobacco rod 56 with a central orifice 64, wherein the central orifice 64 is receivable in the atomizer 26.

This may be in advantage to secure an easy fastening of the tobacco element 46 on the atomizer 26 to allow the user to exchange the tobacco element 46 in regular intervals for different kind of tobaccos 58 or when the tobacco 58 is losing its taste.

In a further improvement of the electronic smoking device 10, the hollow tobacco rod 56 has a cylindric shape. A cylindric tobacco rod 56 can be pressed on the coil housing 40 of the atomizer 26 in any direction, so no orientation of the tobacco rod 56 is needed.

More preferably, on a front side of the tobacco rod 56 a chamfer 66 is formed in order to simplify the attachment of the tobacco rod 56 to the atomizer 26. Adding a chamfer 66 on the tobacco rod 56 enables the user to have an easy and simplified press-fit of the tobacco element 56 on the coil housing 40 of the atomizer 26.

According to another embodiment of the electronic smoking device 10, the tobacco element 56 comprises a retaining element 68, such as a wire or a frame, wherein the tobacco 58 is shaped by the retaining element 68. This may be in advantage to extend the fatigue life of the tobacco element 46 and to avoid that the tobacco 58 crumbles into the gap between the liquid reservoir 34 and the coil housing 40.

In a preferred embodiment of the electronic smoking device 10 the heating element 10 comprises a heating coil. A heating coil may support the wick 30 to increase the stability of the wick and improve the atomization or vaporization of the liquid 44.

In another preferred embodiment of the electronic smoking device 10, the atomizer 26 comprises a coil housing 40, where the tobacco element 46 is connected to the housing 40 of the atomizer 26. The coil housing 40 may have some kind of edge, groove, or stop to simplify the connection of the tobacco element 46 to the coil housing 40.

Another advantage may be that the coil housing 40 has a stop surface 62 to limit the insertion depth of the tobacco element 46. Therefore it is secured, that the tobacco element 46 is not pressed in to far and covers the fluid path between the liquid reservoir 34 and the heating coil 28 such that the tobacco element 46 has to be penetrated to drawn the liquid 44 to the heating coil 28 of the atomizer 26.

More preferably, the coil housing 40 of the atomizer 26 has a chamfer 70 to simplify the sliding of the tobacco element 46 on the coil housing 40. A chamfer 70 on the front of the coil housing 40 orientated towards the tobacco element 46 may avoid the tobacco element 46 for cracking and crumbling when it is pressed on the coil housing 40 of the atomizer 26.

In addition or alternatively, the coil housing 40 of the atomizer 26 has a thickening 72, wherein the tobacco element 46 has a press-fit on the thickening 72 of the coil housing 40. This allows to have an easy press-fitting process, as the tobacco rod 56 is centered by the coil housing 40 and will be kept in position, when the tobacco rod 56 is pushed over the thickening 72 of the coil housing 40. This ensures a fastening position of the tobacco rod 56 when it is pressed on the coil housing 40.

In another preferred embodiment of the electronic smoking device 10 the atomizer 26 comprises a wick 30 and a metal housing 40, wherein the wick 30 is connected to the heating coil 28 and positioned within the housing 40, wherein the tobacco element 46 is formed as a hollow tobacco rod 56, and wherein the tobacco rod 56 is positioned between the liquid reservoir 34 and the housing 40 of the atomizer 26.

More preferably, the housing 40 has an orifice 78 fluidly connecting the liquid reservoir 34 to the wick 30, wherein the tobacco rod 56 is covering the orifice 78, such that a fluid path between the liquid reservoir 34 and the wick 30 is formed via the tobacco rod 56. This ensures that the liquid 44 adsorbs the tobacco taste and the nicotine before being transferred to the wick 30 and vaporized by the heating coil 28.

According to another embodiment of the electronic smoking device 10, the atomizer 26 comprises a wick 30, wherein the wick 30 is at least partly surrounded by the heating coil 28, further comprising a metal housing 40, wherein the tobacco element 46 is placed between the wick 30 and the metal housing 40 of the atomizer 26. In this embodiment of the electronic smoking device 10 the atomizer head is manufactured with a tobacco wick 30 portion on the inside of the atomizer head wall. This means that the outer material of the atomizer head would be the metal coil housing 40, then there would be a layer of tobacco 74 on the inside of the coil housing 40, followed by a porous layer 76 such as cotton or fiberglass fibers, and finally having a preferably vertical heating coil 28 on the inner-most side of the atomizer 26. This means the consumer does not have to buy tobacco rods 56, but rather replaces the atomizer 26 from time to time. Therefore the thickness of the tobacco layer 74 should be adjusted to the thickness of the porous layer 76 to ensure that the tobacco layer lasts 74 as long as the rest of the atomizer head.

More preferably, the wick comprises surrounding tobacco layer, or a tobacco layer is wrapped around a porous layer of the wick. To add the tobacco flavor and the nicotine to the liquid it is preferable that the tobacco layer surrounds the porous layer in order to ensure that the tobacco layer is penetrated by the liquid before the liquid is vaporized or atomized by the heating coil of the atomizer.

While this invention has been described in connection with what is presently considered to be practical exemplary embodiments, it is to be understood that the invention is not limited to the disclosed embodiments, but, on the contrary, is intended to cover various modifications and equivalent arrangements included within the scope of the appended claims.

### LIST OF REFERENCE SIGNS

10 electronic smoking device
12 power supply portion
14 atomizer/liquid reservoir portion
16 end cap
18 power supply/battery
20 light-emitting diode (LED)
22 control electronics
24 airflow sensor
26 atomizer
28 heating element, preferably heating coil
30 wick
32 central passage
34 liquid reservoir
36 air inhalation port
38 air inlets
40 coil housing
42 liquid channel
44 liquid
46 tobacco element
48 outer diameter
50 inner diameter
52 wire
54 cotton
56 tobacco rod
58 tobacco
60 central axis
62 stop surface
64 central orifice
66 chamfer
68 retaining element
70 chamfer
72 thickening
74 tobacco layer
76 porous layer
78 orifice

1. An electronic smoking device (10) comprising:
a power supply portion (12) comprising a power supply (18),
an atomizer/liquid reservoir portion (14) comprising a liquid reservoir (34), and an atomizer (26) operable when connected to the power supply (18) to atomize liquid (44) stored in the liquid reservoir (34), wherein
the atomizer/liquid reservoir portion (14) further comprises a heating element (28), wherein
a tobacco element (46) comprising tobacco (58) is positioned between the liquid reservoir (34) and the heating element (28) of the atomizer (26) such that a liquid (44) stored in the liquid reservoir (34) passes the tobacco element (46) to absorb the tobacco flavor of the tobacco element (46) before being vaporized by the heating element (28).

2. The electronic smoking device (10) according to claim 1, characterized in that the tobacco element (46) is a hollow tobacco rod (56) with a central orifice (64), wherein the central orifice (64) is receivable in the atomizer (26).

3. The electronic smoking device (10) according to claim 2, characterized in that on a front side of the tobacco rod (56) a chamfer (66) is formed in order to simplify the attachment of the tobacco rod (56) to the atomizer (26).

4. The electronic smoking device (10) according to any of claims 1 to 3, characterized in that the tobacco element (46) comprises a retaining element (68), wherein the tobacco (58) is shaped by the retaining element (68).

5. The electronic smoking device (10) according to any of claims 1 to 4, characterized in that the heating element (28) comprises a heating coil.

6. The electronic smoking device (10) according to any of claim 5, characterized in that the atomizer (26) comprises a coil housing (40), wherein the tobacco element (46) is connected to the coil housing (40) of the atomizer (26)

7. The electronic smoking device (10) according to claim 6, characterized in that the coil housing (40) has a stop surface (62) to limit the insertion depth of the tobacco element (46).

8. The electronic smoking device (10) according to claim 6 or claim 7, characterized in that the coil housing (40) of the atomizer (26) has a chamfer (70) to simplify the sliding of the tobacco element (46) on the coil housing (40).

9. The electronic smoking device (10) according to any of the claims 6 to 8, characterized in that coil housing (40) of the atomizer (26) has a thickening (72), wherein the tobacco element (46) has a press-fit on the thickening (72) of the coil housing (40).

10. The electronic smoking device (10) according to any of the claims 1 to 9, the atomizer (26) further comprising a wick (30) and a metal coil housing (40), wherein the wick (30) is connected to the heating coil (28) and positioned within the coil housing (40), wherein the tobacco element (46) is formed as a hollow tobacco rod (56), and wherein the tobacco rod (56) is positioned between the liquid reservoir (34) and the coil housing (40) of the atomizer (26).

11. The electronic smoking device (10) according to claim 10, wherein the coil housing (40) has an orifice (78) fluidly connecting the liquid reservoir (34) to the wick (30), wherein the tobacco rod (56) is covering the orifice (78), such that a fluid path between the liquid reservoir (34) and the wick is formed via the tobacco rod (56).

12. The electronic smoking device (10) according to claim 1, the atomizer (26) comprises a wick (30), wherein the wick (30) is at least partly surrounded by the heating element (28) and a metal coil housing (40), wherein the tobacco element (46) is placed between the wick (30) and the metal coil housing (40) of the atomizer (26).

13. The electronic smoking device (10) according to claim 12, wherein the wick (30) comprises a tobacco layer (74) or a tobacco layer (74) is wrapped around a porous layer (76) of the wick (30).

14. A method of assembling an electronic smoking device (10) according to any of the claims 1 to 11, wherein a tobacco element (46) is inserted into a central passage (32) of the electronic smoking device (10) and connected to the atomizer (26), wherein the tobacco element (46) is fluidly connected to the liquid reservoir (34) such that a liquid (44) is transported to the atomizer via the tobacco element (46).

15. An atomizer/liquid reservoir portion (14) comprising:
a liquid reservoir (34), and
an atomizer (26) operable when connected to a power supply (18) for an electronic smoking device (10) to atomize liquid stored in the liquid reservoir (34),
wherein
the atomizer/liquid reservoir portion (14) further comprises a heating element (28) and a tobacco element (46), wherein the tobacco element (46) is positioned between the liquid reservoir (34) and the heating element (28) of the atomizer (26) such that a liquid (44) stored in the liquid reservoir (34) passes the tobacco element (46) to adsorb the tobacco flavour of the tobacco element (46) before being vaporized by the heating element (28).
